(19) United States
(12) Patent Application Publication
(10) Pub. No.: US 2010/0073596 A1
(43) Pub. Date: Mar. 25, 2010

(54) BACKLIGHT ASSEMBLY HAVING AN ELASTIC SUPPORTING MEMBER FOR SUPPORTING OPTICAL MEMBER AND A DISPLAY APPARATUS HAVING THE SAME

(75) Inventors: Hyun-Chul JEONG, Asan-si (KR); Yong-Woo KIM, Seoul (KR); Sang-Sun HAN, Cheonan-si (KR); Dong-Wook KIM, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, (KR)

(21) Appl. No.: 12/555,822

(22) Filed: Sep. 9, 2009

(30) Foreign Application Priority Data
Sep. 19, 2008 (KR) 10-2008-0092256

(51) Int. Cl. G02F 1/1333; G02F 1/13357

(52) U.S. Cl. 349/60; 349/62

(57) ABSTRACT

A backlight assembly which includes a light source generating light supplied to the liquid crystal panel, optical members controlling characteristics of the light provided from the light source, a receiving container including a receiving area receiving the light source and the optical members, a rear surface defining a plane, and a first recess protruding toward the receiving area from an exterior of the receiving container and an elastic supporting member assembled to the first recess of the receiving container, and supporting the optical members. The first recess has a depth from the plane of the rear surface, such that the supporting member does not protrude past the plane of the rear surface of the receiving container.

This application claims priority to Korean Patent Application No. 10-2008-0092256 filed on Sep. 19, 2008, and all the benefits accruing therefrom under 35 U.S.C. § 119, the contents of which are incorporated herein by reference in its entirety.

### BACKGROUND OF THE INVENTION

1. Field of the Invention

The present invention relates to a backlight assembly having an elastic supporting member for supporting an optical member and a display apparatus having the same.

2. Description of the Related Art

The liquid crystal display (“LCD”) is one of the most extensively used flat panel displays. The liquid crystal display is provided with two substrates on which field-generating electrodes are formed, and a liquid crystal layer that is interposed between the substrates. In the liquid crystal display, a voltage is applied to the electrodes to rearrange the liquid crystal molecules of the liquid crystal layer, thereby controlling the quantity of transmitted light.

Since liquid crystal molecules change a display panel's transmissivity of incident light by the orientation and intensity of an electric field, the LCD requires a light source that provides a liquid crystal panel with light to display images. The LCD employs a light source such as a light emitting diode (“LED”), a cold cathode fluorescent lamp (“CCFL”), or a flat fluorescent lamp (“FFL”).

The LCD includes a liquid crystal panel assembly including a pair of substrates with a liquid crystal layer interposed therebetween, and a backlight assembly. The backlight assembly includes a plurality of lamps, various optical sheets, a diffusing plate, and a receiving container.

The conventional LCD includes a supporting member to support a diffusing plate from a lower portion of the diffusing plate.

### BRIEF SUMMARY OF THE INVENTION

While an LCD includes an elastic supporting member to support a diffusing plate from a lower portion of the diffusing plate, there may be technical difficulties and disadvantages. For example, when the LCD is vibrated during assembling, carrying or installing, relatively sharp tip portions of the elastic supporting member may cause scratches to a diffusion plate. In addition, since the elastic supporting member is externally inserted into and fixed to a receiving container, the LCD may become bulky and relatively thicker by the supporting member having outwardly protruding portions, making it difficult to achieve an LCD being compact and light in weight.

Exemplary embodiments of the present invention provide a back light assembly including an elastic supporting member supporting an optical member, which can facilitate connection with a receiving container and prevent scratches from being generated at optical members due to external vibration.

Exemplary embodiments, of the present invention also provide a display apparatus which is relatively compact in size and light in weight, and includes a supporting member supporting an optical member.

In an exemplary embodiment of the present invention, there is provided a back light assembly including a light source generating light supplied to the liquid crystal panel, optical members controlling characteristics of the light provided from the light source, a receiving container including a receiving area receiving the light source and the optical members, a rear surface defining a plane, and a first recess protruding toward the receiving area from an exterior of the receiving container, and an elastic supporting member assembled to the first recess of the receiving container, and supporting the optical members.

The first recess has a depth from the plane of the rear surface, such that the supporting member does not protrude past the plane of the rear surface of the receiving container.

The elastic supporting member comprises a base disposed in the first recess, and facing a portion of the rear surface of the receiving container, an elastic supporting portion disposed on the base, disposed in the receiving area of the receiving container, and supporting the optical members, and a hooking groove disposed at an exterior side of the elastic supporting portion, the hooking groove engaged with a portion of the receiving container.

The base has a shape of a plate, and the first recess has a depth from the plane of the rear surface, such that the base does not protrude past the plane of the rear surface of the receiving container.

The elastic supporting portion includes first and second elastic portions, and top ends of the first and second elastic portions are connected to each other and define an opening portion between the first and second elastic portions.

The elastic supporting portion includes first through fourth elastic portions, and top ends of the first through fourth elastic portions are separated from one another.

The back light assembly may further comprise a reflective plate disposed between the light source and the receiving container, reflecting light upward from below the light source, and including a throughhole through which the supporting member passes.

The throughhole has a larger diameter than the first recess, and the reflective plate completely surface-contacts the receiving container.

The back light assembly may further comprise a reflective plate disposed between the light source and the receiving container, reflecting light upward from below the light source, and including a throughhole through which the supporting member passes.

The throughhole has a smaller diameter than the first recess.

The receiving container further includes a second recess contacting a lower surface of the reflective plate.

The light source comprises an LED assembly, the LED assembly comprising a substrate, and LED chips disposed on the substrate.

The elastic supporting member supports the optical members by being inserted into the substrate via a first through hole formed in the substrate.

The LED assembly comprises a plurality of substrates, and the elastic supporting member supports the optical members by being disposed between the adjacent substrates.

In an exemplary embodiment of the present invention, there is provided a display including a liquid crystal panel displaying image information, a light source generating light supplied to the liquid crystal panel, optical members arranged between the liquid crystal panel and the light source, and controlling characteristics of the light, a receiving container including a receiving area receiving the light source and the optical members, a rear surface defining a plane, and a first recess protruding toward the receiving area from an exterior of the receiving container, and an elastic supporting member assembled to the first recess of the receiving container, and supporting the optical members.

The first recess has a depth from the plane of the rear surface, such that the supporting member does not protrude past the plane of the rear surface of the receiving container.

The elastic supporting member may comprise a base disposed in the first recess, and facing a portion of the rear surface of the receiving container, an elastic supporting portion disposed on the base, disposed in the receiving area of the receiving container, and supporting the optical members, and a hooking groove disposed at an exterior side of the elastic supporting portion, the hooking groove engaged with a portion of the receiving container.

The base has a shape of a plate, and the first recess has a depth from the plane of the rear surface, such that the base does not protrude past the plane of the rear surface of the receiving container.

The elastic supporting portion includes first and second elastic portions, and top ends of the first and second elastic portions are connected to each other and define an opening portion between the first and second elastic portions.

The elastic supporting portion includes first through fourth elastic portions, and top ends of the first through fourth elastic portions are separated from one another.

The display apparatus may further comprise a reflective plate disposed between the light source and the receiving container, reflecting light upward from below the light source, and including a throughhole through which the supporting member passes.

The throughhole has a smaller diameter than the first recess, and the receiving container further includes a second recess contacting a lower surface of the reflective plate.

The light source comprises an LED assembly comprising at least one substrate and LED chips disposed on the substrate, and wherein the elastic supporting member supports the optical members by being inserted into the substrate via a first through hole formed in the substrate.

The light source comprises an LED assembly comprising a plurality of substrates and LED chips disposed on the substrate, and the elastic supporting member supports the optical members by being disposed between the adjacent substrates.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of an exemplary embodiment of a liquid crystal display according to the present invention;

FIG. 2 is a cross-sectional view taken along line A-A′ of FIG. 1;

FIG. 3 is a perspective view illustrating a first exemplary embodiment of an elastic supporting member according to the present invention;

FIG. 4 is a perspective view illustrating an exemplary embodiment of an assembled state of the elastic supporting member and a lower receiving container shown in FIG. 3;

FIG. 5 is a cross-sectional view of the elastic supporting member shown in FIG. 3;

FIG. 6 is a perspective view illustrating a second exemplary embodiment of an elastic supporting member according to the present invention;

FIG. 7 is a cross-sectional view of a third exemplary embodiment of an elastic supporting member according to the present invention;

FIG. 8 is a cross-sectional view of a fourth exemplary embodiment of an elastic supporting member according to the present invention;

FIG. 9 is a cross-sectional view of a fifth exemplary embodiment of an elastic supporting member according to the present invention;

FIG. 10 is a cross-sectional view of a sixth exemplary embodiment of an elastic supporting member according to the present invention;

FIG. 11 is a cross-sectional view of seventh exemplary embodiment of an elastic supporting member according to the present invention;

FIG. 12 is an exploded perspective view of an exemplary embodiment of a liquid crystal display including an elastic supporting member according to an eighth exemplary embodiment of the present invention; and

FIG. 13 is a cross-sectional view of a ninth embodiment of a liquid crystal display including an elastic supporting member according to a ninth exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification. In the drawings, the thicknesses of layers and regions are exaggerated for clarity.

It will be understood that when an element or layer is referred to as being “on” another element or layer, it can be directly on to the other element or layer or intervening elements or layers may be present. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

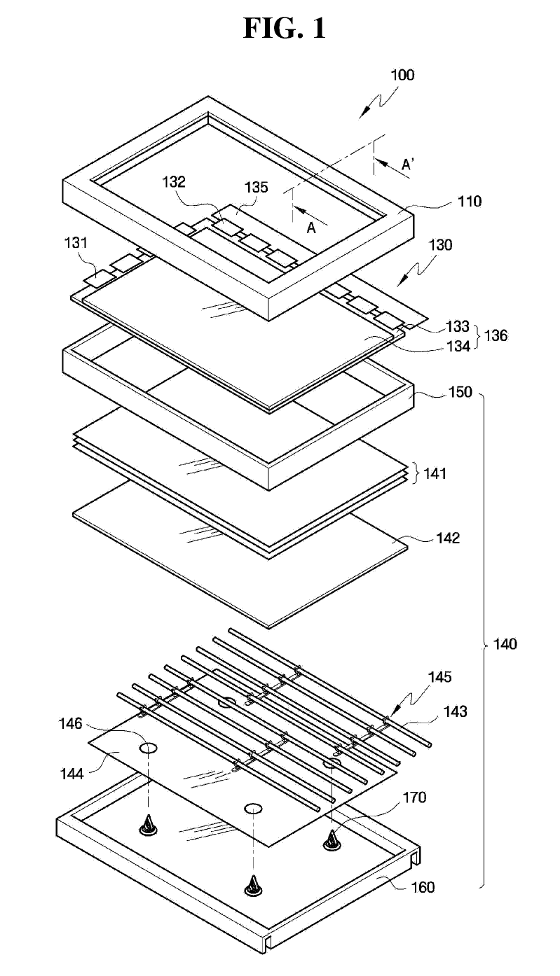

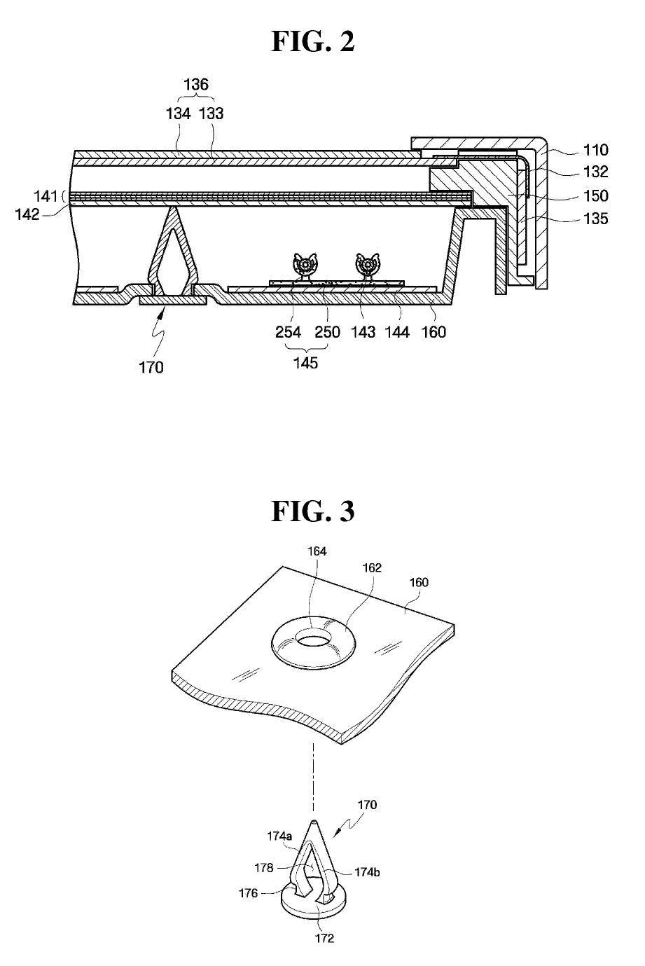

Hereinafter, a liquid crystal display (“LCD”) according to an exemplary embodiment of the present invention will be described in detail with reference to FIGS. 1 and 2. FIG. 1 is an exploded perspective view of an exemplary embodiment of an LCD according to the present invention, and FIG. 2 is a cross-sectional view taken along line A-A′ of FIG. 1.

Referring to FIGS. 1 and 2, the LCD 100 includes a liquid crystal panel assembly 130 displaying image information, a backlight assembly 140 supplying the liquid crystal panel assembly 130 with light, and an upper receiving container 110 connected to the backlight assembly 140 and receiving the liquid crystal panel assembly 130.

The liquid crystal panel assembly 130 includes a liquid crystal panel 136 including a lower display panel 133 and an upper display panel 134, liquid crystals (not shown), a plurality of a gate tape carrier package 131, a plurality of a data tape carrier package 132, and a printed circuit board 135.

In the liquid crystal panel 136, the lower display panel 133 includes gate lines (not shown), data lines (not shown), an array of TFTs (not shown), pixel electrodes (not shown), and other various components. The upper display panel 134 includes black matrices (not shown), a common electrode (not shown), and other various components. The upper display panel 134 is disposed opposite to and facing the lower display panel 133, with respect to the liquid crystals.

The gate tape carrier packages 131 are respectively connected to the gate lines in the lower display panel 133, and the data tape carrier packages 132 are respectively connected to the data lines in the lower display panel 133.

In an exemplary embodiment, driving devices (not shown) processing gate driving signals and data driving signals, may be mounted on the printed circuit board 135 to apply the gate driving signals and the data driving signals to the gate tape carrier packages 131 and the data tape carrier packages 132, respectively.

The backlight assembly 140 includes a plurality of a planar optical member (e.g., optical sheets) 141, a planar diffusion member (e.g., plate) 142, a light source 143 such as a lamp generating light, a reflective planar member (e.g., plate) 144, an intermediate receiving frame 150 and a lower receiving container 160. The backlight assembly 140 may include a plurality of the light source 143 each generating light.

The lamps 143 may be cold cathode fluorescent lamps (“CCFLs”), external electrode fluorescent lamps (“EEFLs”), or various other types of light emitting devices. The lamps 143 generate light using a lamp driving voltage externally applied to the lamps 143. According to an exemplary embodiment, the lamps 143 may extend in a longitudinal direction of the LCD, and be spaced apart from each other by a predetermined distance in a transverse direction of the LCD. In the illustrated embodiment, the backlight assembly 140 may be of a direct type, such that the lamps 143 supply light directly to the liquid crystal panel 136, and more specifically emit light directly to the diffusion plate 142 in FIG. 1.

In order to achieve substantial uniformity of brightness in an exemplary embodiment, by uniformly distributing a discharge gas in the lamps 143, the lamps 143 may be arranged substantially horizontally with respect to the liquid crystal panel 136, being substantially parallel with a plane of the liquid crystal panel 136. Lamp sockets (not shown) may be positioned to correspond to end portions of the lamps 143 and securely support the lamps 143 by applying lamp driving voltages to the lamps 143.

The diffusion plate 142 may be disposed directly on the lamps 143, and serves to enhance the brightness uniformity of light generated from the lamps 143. In an exemplary embodiment, the diffusion plate 142 may include polymethyl methacrylate (“PMMA”), methyl styrene (“MS”), polystyrene (“PS”), polycarbonate (“PC”), or the like.

The reflective plate 144 is disposed below the lamps 143, facing the lamps 143 and reflects light upward from below the lamps 143. The reflective plate 144 is disposed opposite to the diffusion plate 142 and the optical sheets 141 with respect to the lamps 143. An entire of the reflective plate 144 may overlap a whole of the diffusion plate 142 and the optical sheets 141. The reflective plate 144 may include highly elastic, highly reflective material that can be used in a relatively thin profile, e.g., such as a foil.

In one exemplary embodiment, the reflective plate 144 may include PET (polyethylene terephthalate). In another exemplary embodiment, the reflective plate 144 may include a coating of a reflective film on a highly elastic, thin material. Alternatively, the reflective plate 144 may be integral with the bottom surface of the lower receiving container 160, such that the reflective plate 144 and the bottom surface of the lower receiving container 160 are a single, continuous and indivisible member. If the lower receiving container 160 includes a highly reflective material, exemplary embodiments of which include aluminum (Al) or aluminum alloy, the lower receiving container 160 itself can serve as the reflective plate 144, and thereby define a single, continuous and indivisible member of the backlight assembly 140.

A lamp fixing unit 145 disposed on the reflective plate 144 may be used to fix the lamps 143 in a position relative to each other, and relative to other features of the backlight assembly 140. Referring to FIG. 2, the lamp fixing unit 145 includes a planar support member (e.g., plate) 250 disposed on the reflective plate 144, and a grip portion 254 disposed on the support plate 250 to fix the lamps 143. A lower surface of the support plate 250 is disposed directly on and contacting an upper surface of the reflective plate 144. Referring again to FIGS. 1 and 2, an entire of the lower surface of the support plate 250 overlaps a portion of the reflective plate 144. A lower surface of the grip portion 254 is disposed directly on an upper surface of the support plate 250. Referring to FIGS. 1 and 2, an entire of the lower surface of the grip portion 254 overlaps a portion of the support plate 250. A single one of the plurality of lamps 143 is disposed in the grip portion 254, such as being disposed between two distal ends of the grip portion 254.

The optical sheets 141 are disposed directly on the diffusion plate 142, and serve to diffuse and focus light originating from the lamps 143. Exemplary embodiments of the optical sheets 141 include a diffusion sheet, a first prism sheet, a second prism sheet, and various other sheets with similar properties. Here, the diffusion sheet 142 is disposed above the lamps 143, and serves to enhance the brightness and brightness uniformity of incident light from the lamps 143.

The first prism sheet of the optical sheets 141 may be disposed directly on an upper surface of the diffusion sheet 142. Exemplary embodiments of the prism sheet include, but are not limited to, triangonal prism patterns (not shown) substantially uniformly arranged on a surface of the first prism sheet to focus light diffused from the diffusion sheet and to output the focused light. The second prism sheet may be disposed directly on the first prism sheet, and opposing the diffusion plate 142 relative to the first prism plate. The second prism sheet may be a multi-layered, reflective, polarization prism sheet which focuses, polarizes, and outputs light incident thereto. In the exemplary embodiment where the first prism sheet provides sufficient brightness and viewing angle, the second prism sheet may be omitted. The configuration of the optical sheets 141 is not limited to the illustrated exemplary embodiment and may be modified in various manners according to the specification of the backlight assembly 140.

The reflective plate 144, the lamps 143, the diffusion plate 142, and the optical sheets 141 are sequentially placed in the lower receiving container 160 from a lower side (e.g., rear) of the LCD 100. In an exemplary embodiment, the receiving frame 150 may be assembled with the lower receiving container 130, such as by lowering the receiving frame 150 from an upper portion (e.g., side) of the lower receiving container 160, to then be coupled to the lower receiving container 160.

The liquid crystal panel assembly 130 is disposed directly on the optical sheets 141. The liquid crystal panel assembly 130 is received in the lower receiving container 160, and is supported by the receiving frame 150. The receiving frame 150 may include sidewalls extending from edges of a bottom surface. In one exemplary embodiment the receiving frame 150 is structured such that the liquid crystal panel assembly 130 contacts and is supported by stepped portions and/or projections disposed inside the sidewalls of the receiving frame 150.

The lower receiving container 160 has a substantially planar (e.g., flat) bottom surface, and receives the optical sheets 141, the diffusion plate 142, the lamps 143, the reflective plate 144, and the liquid crystal panel assembly 130 in an area defined by sidewalls extending from edges of the bottom surface. The bottom surface of the lower receiving container 160 may be a solid and continuous member as illustrated in FIG. 1, or may include openings exposing a lower (e.g., rear) surface of the reflective plate 144. The sidewalls extending from the edges of the bottom surface, and the bottom surface may together define a receiving area of the lower receiving container 160.

In an exemplary embodiment, the printed circuit board 135 of the liquid crystal panel assembly 130 may be folded along an outer side and edge of the lower receiving container 160, such that the printed circuit board 135 is disposed on a sidewall and/or a rear surface of the lower receiving container 160. The shape of the lower receiving container 160 can be changed according to how the optical sheets 141, the optical plate 142, the lamps 143, the reflective plate 144, or the liquid crystal panel assembly 130 are placed in the lower receiving container 160. As used herein, with reference to FIG. 1, a lowermost side or surface of the LCD may be referred to as a “rear side,” and an uppermost side or surface of the LCD may be referred to as a “front side” or a “viewing side.”

The lower receiving container 160 is coupled to the upper receiving container 110 such that a periphery of an upper surface of the liquid crystal panel assembly 130 received in the lower receiving container 160 is covered. As illustrated in FIGS. 1 and 2, an upper surface of the upper receiving container 110 overlaps edges of the LC panel 136, the optical sheets 141 and the diffusion plate 142. A portion of the upper surface of the upper receiving container 110 may also overlap an entire of the receiving frame 150. A window exposing the liquid crystal panel assembly 130 to the outside is disposed on the upper surface of the upper receiving container 110.

Exemplary embodiments of the coupling between the upper receiving container 110 and the lower receiving container 160 can be accomplished by hooking (not shown) and/or screwing (not shown).

Referring to FIGS. 1 and 2, an elastic supporting member 170 may be inserted from a rear (e.g., an outer portion) of the lower receiving container 160 and fixed to the lower receiving container 160, serving to reduce or effectively prevent sagging and/or deforming of the optical members, such as the diffusion plate 142, the optical sheets 141, and the like. As shown in FIG. 2, a lowermost surface of the elastic supporting member 170 is substantially coplanar with a rear surface of the lower receiving container 160.

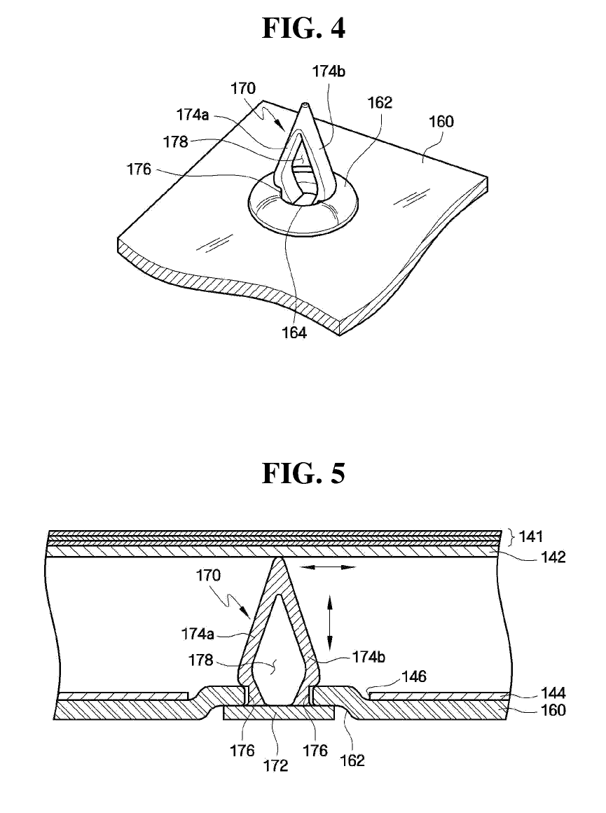

Hereinafter, the elastic supporting member 170 supporting optical members used for the LCD according to the first embodiment of the present invention will be described with reference to FIGS. 3 through 5. FIG. 3 is a perspective view illustrating a first exemplary embodiment of an elastic supporting member according to the present invention, FIG. 4 is a perspective view illustrating an exemplary embodiment of an assembled state of the elastic supporting member and a lower receiving container shown in FIG. 3, and FIG. 5 is a cross-sectional view of the elastic supporting member shown in FIG. 3.

Referring to FIGS. 3 through 5, a recess 162 projecting on an inside surface is disposed on the bottom surface of the lower receiving container 160, and a coupling hole 164 into which the elastic supporting member 170 is inserted, is disposed in the recess 162. The coupling hole 164 defines an enclosed opening penetrating the bottom surface of the lower receiving container 160, and the lower receiving container 160 including the recess 162 solely defines the coupling hole 164 as an enclosed opening.

Referring to FIG. 5, portions of the bottom surface of the lower receiving container 160 defining the coupling hole 164, are disposed deviated inwardly from a plane of a remaining portion of the bottom surface of the receiving container 160. The portions of the bottom surface of the lower receiving container 160 defining the coupling hole 164 are not coplanar with the remaining portion of the bottom surface of the receiving container 160. The portions of the bottom surface of the lower receiving container 160 defining the coupling hole 164 solely define the recess 162, and are disposed at a distance away from the plane of an outer surface of the remaining portion of the bottom surface of the receiving container 160. The portions of the bottom surface of the lower receiving container 160 are continuous with the remaining portion of the bottom surface of the receiving container 160.

As the portions of the bottom surface of the lower receiving container 160 defining the coupling hole 164, are deviated inwardly from the plane of an outer surface of the remaining portion of the bottom surface of the receiving container 160, the portions of the bottom surface are also deviated outwardly from a plane of an inner surface of the remaining portion of the bottom surface of the receiving container 160. The recess 162 protrudes from the inner surface of the bottom surface (e.g., in the receiving area), and is recessed from the outer surface of the bottom surface.

The elastic supporting member 170 includes a base 172, and an elastic supporting portion disposed on the base 172 and supporting the diffusion plate 142. Here, the base has a shape of a plate, and the elastic supporting portion includes first and second elastic portions 174a, 174b. Bottom ends of the first elastic portion 174a and the second elastic portion 174b are separated from each other, and are fixed on the base 172. The bottom ends of the first elastic portion 174a and the second elastic portion 174b directly contact an upper surface of the base 172. Top ends of the first elastic portion 174a and the second elastic portion 174b are connected to each other. The connection of the first elastic portion 174a and the second elastic portion 174b defines a distal end of the overall elastic supporting member 170. The first elastic portion 174a and the second elastic portion 174b are a single and continuous member.

An opening portion 178 is formed between the first elastic portion 174a and the second elastic portion 174b. A distance between the first elastic portion 174a and the second elastic portion 174b define the opening portion 178 of the supporting member 170.

A hooking groove 176 is disposed along the exterior side of a lower portion of each of the first elastic portion 174a and the second elastic portion 174b. The hooking groove 176 is defined by a portion of each of the first elastic portion 174a and the second elastic portion 174b extended outwardly further than the bottom ends of the first elastic portion 174a and the second elastic portion 174b.

In an exemplary embodiment, when the supporting member 170 is inserted into the coupling hole 164 of the recess 162, the lower receiving container 160 is fittingly coupled into the hooking groove 176, thereby reducing or effectively preventing deviation of the elastic supporting member 170 from the lower receiving container 160. The portion of each of the first elastic portion 174a and the second elastic portion 174b defining the hooking groove 176 has a larger diameter than the coupling hole 164. The portion of each of the first elastic portion 174a and the second elastic portion 174b defining the hooking groove 176 overlaps edges of the coupling hole 164. The base 172 of the elastic supporting member 170 preferably has a larger diameter than the coupling hole 164. A first planar surface area of the base 172, is larger than a second planar surface area of the recess 162 and the coupling hole 164. The engagement of both the base 172 and the hooking groove 176 with the bottom surface of the lower receiving container 160 solely retains the elastic supporting member 170 with the lower receiving container 160.

Referring to FIG. 5, when the elastic supporting member 170 is fully inserted into the coupling hole 164, the base 172 is substantially completely accommodated in the recess 162. In an exemplary embodiment, the recess 162 is preferably depressed from the bottom surface of the lower receiving container 160, by a predetermined depth sufficient enough for the base 172 not to protrude outside the lower receiving container 160. A depth of the recess 162 is a maximum dimension taken in a direction substantially perpendicular to the bottom surface of the lower receiving container 160. When the elastic supporting member 170 is fully inserted in to the coupling hole 164, a lowermost surface of the elastic supporting member 170, e.g., a bottom surface of the base 172, is substantially coplanar with a rear surface of the lower receiving container 160. Advantageously, the elastic supporting member 170 does not protrude outside of the lower receiving container 160.

In addition, since the base 172 of the elastic supporting member 170 is provided at an exterior side of the recess 162 of the lower receiving container 160, protruding of the elastic supporting member 170 to the outside the lower receiving container 160 is reduced, or effectively prevented. As described above, since there is no structure of the backlight assembly 140 protruding outside the lower receiving container 160, a slimmer, lightweight LCD can be advantageously achieved.

Referring again to FIGS. 1 and 5, a throughhole 146 into which the elastic supporting member 170 is additionally inserted, is disposed in the reflective plate 144. The throughhole 146 of the reflective plate 144 is aligned with the coupling hole 146 in the lower receiving container 160. In an exemplary embodiment, the throughhole 146 may have a relatively large diameter so that the protruding portion of the recess 162 of the lower receiving container 160 can be inserted into the throughhole 146. As illustrated in FIG. 5, an entire lower surface of the reflective plate 144 contacts a portion of an upper surface of the bottom surface of the receiving container 160. Accordingly, the reflective plate 144 can completely surface-contact the lower receiving container 160 without coming off the lower receiving container 160.

As shown in FIG. 5, the elastic supporting member 170 includes the first elastic portion 174a and the second elastic portion 174b separated from each other to form the opening portion 178. With the first elastic portion 174a and the second elastic portion 174b being separated from each other, the elastic supporting member 170 has elasticity in transverse and longitudinal directions of the elastic supporting member 170.

When the elastic supporting member 170 is inserted into the lower receiving container 160 from the exterior side of a lower receiving container 160, a distance between the first elastic portion 174a and the second elastic portion 174b is reduced in the transverse direction (indicated by the horizontal arrow in FIG. 5), thereby facilitating the inserting of the elastic supporting member 170 into the coupling hole 164. Conversely, the elastic supporting member 170 may be removed from the coupling hole 164 of the lower receiving container 160, such as by moving the first elastic portion 174a and the second elastic portion 174b towards each other in the transverse direction and reducing the distance therebetween until the supporting member can be pushed back through the coupling hole 164. The elastic supporting member 170 is removably disposed with the lower receiving container 160, due to the elasticity of the elastic supporting member 170.

In addition, when a force is applied in the longitudinal direction of the elastic supporting member 170 (indicated by the vertical arrow in FIG. 5), the distance between the first elastic portion 174a and the second elastic portion 174b is increased, and an overall height of the elastic supporting member 170 is reduced. Since the elastic supporting member 170 is deformable (e.g., shrinkable) in the longitudinal direction to reduce the overall height of the elastic supporting member 170, the elastic supporting member 170 can absorb an impact in the longitudinal direction. Advantageously, the elastic supporting member 170 can effectively reduce or prevent scratches from being caused to the diffusion plate 142 contacting the upper end of the elastic supporting member 170.

When the force in the longitudinal direction of the elastic supporting member 170 is removed, the elastic supporting member 170 returns to an original height and separation of the first elastic portion 174a and the second elastic portion 174b, due to the elasticity of the elastic supporting member 170.

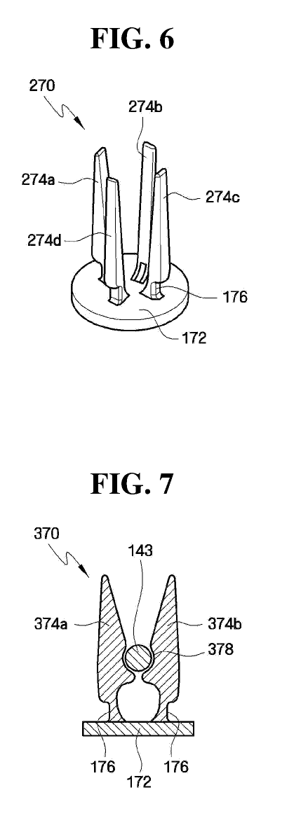

Hereinafter, a elastic supporting member supporting an optical member according to second exemplary embodiment of the present invention will be described in detail with reference to FIG. 6. FIG. 6 is a perspective view illustrating a second exemplary embodiment of an elastic supporting member according to the present invention. For convenience of illustration, the same functional elements as those in the first exemplary embodiment, shown in FIGS. 1 through 5, are represented by the same reference numerals, and a detailed description thereof will be omitted. Thus, the following description will be focused on such differences.

The elastic supporting member 270 includes a base 172, and an elastic supporting portion which is disposed on the base 172 and support a diffusion plate 142. Here, the base has a shape of a plate, and the elastic supporting portion includes a first elastic portion 274a, a second elastic portion 274b, a third elastic portion 274c, and fourth elastic portion 274d, which are disposed on the base 172 and support a diffusion plate 142.

Bottom ends of the first elastic portion 274a, the second elastic portion 274b, the third elastic portion 274c, and the fourth elastic portion 274d are separated from one another, and directly contact the base 172. Top (distal) ends of the first elastic portion 274a, the second elastic portion 274b, the third elastic portion 274c, and the fourth elastic portion 274d are also separated from one another

A hooking groove 176 is disposed along the exterior side of a lower portion of each of the first elastic portion 274a, the second elastic portion 274b, the third elastic portion 274c, and the fourth elastic portion 274d. For uniform distribution of force, the first elastic portion 274a, the second elastic portion 274b, the third elastic portion 274c, and the fourth elastic portion 274d may be concentrically arranged.

In an exemplary embodiment, the elastic supporting member 270 may include an elastic material, and the first elastic portion 274a, the second elastic portion 274b, the third elastic portion 274c, and the fourth elastic portion 274d, which are separated from one another. Thus, the elastic supporting member 270 may have elasticity in transverse and longitudinal directions. When the elastic supporting member 270 is inserted into a lower receiving container 160 from the exterior side of the lower receiving container 160, distances between each of the first elastic portion 274a, the second elastic portion 274b, the third elastic portion 274c, and the fourth elastic portion 274d are reduced, thereby facilitating the inserting of the elastic supporting member 270.

In addition, when a force is applied in the longitudinal direction of the elastic supporting member 270, the distance between each of the first elastic portion 274a, the second elastic portion 274b, the third elastic portion 274c, and the fourth elastic portion 274d is increased, and an overall height of the elastic supporting member 270 is reduced. Since the elastic supporting member 270 is easily shrinkable in the longitudinal direction due to a force applied in the longitudinal direction of the elastic supporting member 270, scratches to the diffusion plate 142 contacting the upper end of the elastic supporting member 270 are reduced or effectively prevented.

Alternatively, when a force is applied in the longitudinal direction of the elastic supporting member 270, the first elastic portion 274a, the second elastic portion 274b, the third elastic portion 274c, and the fourth elastic portion 274d may be deformed (e.g., bent) to bow inwardly or outwardly, and an overall height of the elastic supporting member 270 is reduced. Since the elastic supporting member 270 is easily shrinkable in the longitudinal direction due to a force applied in the longitudinal direction of the elastic supporting member 270, scratches to the diffusion plate 142 contacting the upper end of the elastic supporting member 270 are reduced or effectively prevented.

Hereinafter, an elastic supporting member according to the present invention will be described in detail with reference to FIG. 7. FIG. 7 is a cross-sectional view of a third exemplary embodiment of an elastic supporting member according to the present invention. For convenience of illustration, the same functional elements as those in the second exemplary embodiment, shown in FIGS. 1 through 5, are represented by the same reference numerals, and a detailed description thereof will be omitted. Thus, the following description will be focused on such differences.

The elastic supporting member 370 includes a base 172, and an elastic supporting portion disposed on the base 172 and supporting a diffusion plate 142. Here, the base 172 has a shape of a plate, and the elastic supporting portion includes a first elastic portion 374a and a second elastic portion 374b disposed on the plate 172 and supporting a diffusion plate 142. Bottom ends of the first elastic portion 374a and the second elastic portion 374b are separated from each other, and directly contact the plate 172. Top (distal) ends of the first elastic portion 374a and the second elastic portion 374b are also separated from each other. A hooking groove 176 is disposed along the exterior side of a lower portion of each of the first elastic portion 374a and the second elastic portion 374b. A lamp insertion groove 378 is disposed at the interior portion of the first elastic portion 374a and the second elastic portion 374b, so that a lamp 143 may be accommodated in the lamp insertion groove 378. Thus, the elastic supporting member 370 supports the diffusion plate 142 while simultaneously fixing the lamp 143, such as the lamp fixing unit 145 fixes the lamp 143 in FIG. 2.

The elastic supporting member 370 may include an elastic material, and the first elastic portion 374a and the second elastic portion 374b, which are separated from each other. Thus, the elastic supporting member 370 may have elasticity in transverse and longitudinal directions.

When the elastic supporting member 370 is inserted into the lower receiving container 160 from the exterior side of the lower receiving container 160, a distance between the first elastic portion 374a and the second elastic portion 374b is reduced, thereby facilitating the inserting of the elastic supporting member 370. In addition, when a force is applied in the longitudinal direction of the elastic supporting member 370, the distance between each of the first elastic portion 374a and the second elastic portion 374b is increased, and an overall height of the elastic supporting member 370 is reduced. Since the elastic supporting member 370 is easily shrinkable in the longitudinal direction due to a force applied in the longitudinal direction of the elastic supporting member 370, scratches to the diffusion plate 142 contacting the upper end of the elastic supporting member 370 may be reduced or effectively prevented.

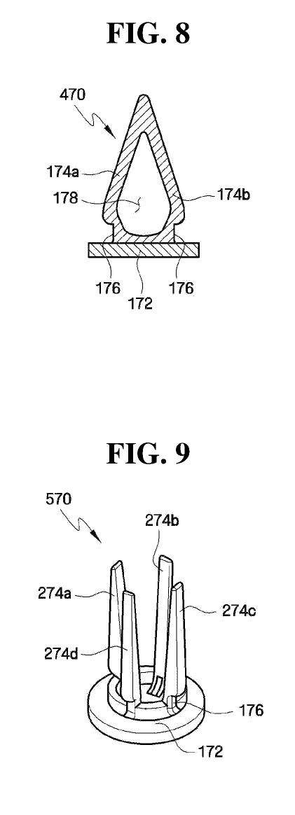

Hereinafter, an elastic supporting member according to a fourth exemplary embodiment of the present invention will be described with reference to FIG. 8. FIG. 8 is a cross-sectional view of a fourth exemplary embodiment of an elastic supporting member according to the present invention. For convenience of illustration, the same functional elements as those in the second exemplary embodiment, shown in FIGS. 1 through 5, are represented by the same reference numerals, and a detailed description thereof will be omitted. Thus, the following description will be focused on such differences.

The supporting member 470 includes a base 172, and an elastic supporting portion disposed on the base 172 and supporting the diffusion plate 142. Here, the base has a shape of a plate, and the elastic supporting portion includes a first elastic portion 174a and a second elastic portion 174b disposed on the base 172 and supporting the diffusion plate 142. Top and bottom ends of the first elastic portion 174a and the second elastic portion 174b are connected to one another, respectively, such as to form an enclosed feature defined solely by the first elastic portion 174a and the second elastic portion 174b. As shown in FIG. 8, a connecting portion may be considered disposed between bottom ends of the first elastic portion 174a and the second elastic portion 174b. The first elastic portion 174a and the second elastic portion 174b are a single and continuous member, including the connecting portion.

The first elastic portion 174a and the second elastic portion 174b include hollow portions in their central portions, forming an opening portion 178. Since bottom ends of the first elastic portion 174a and the second elastic portion 174b are connected to one another, respectively, such as to form an enclosed feature, a portion of the first elastic portion 174a and the second elastic portion 174b is disposed between the base 172 and the opening portion 178. Accordingly, the elastic supporting member 470 may have elasticity in transverse and longitudinal directions.

When the elastic supporting member 470 is inserted into the lower receiving container 160 from the exterior side of the lower receiving container 160, a distance between the first elastic portion 174a and the second elastic portion 174b is reduced, thereby facilitating the inserting of the elastic supporting member 470. In addition, when a force is applied in the longitudinal direction of the elastic supporting member 470, the distance between each of the first elastic portion 174a and the second elastic portion 174b is increased, and an overall height of the elastic supporting member 470 is reduced Since the elastic supporting member 470 is easily shrinkable in the longitudinal direction due to a force applied in the longitudinal direction of the elastic supporting member 370, scratches to the diffusion plate 142 contacting the upper end of the elastic supporting member 470 may be reduced or effectively prevented.

Hereinafter, an elastic supporting member according to a fifth exemplary embodiment of the present invention will be described with reference to FIG. 9. FIG. 9 is a cross-sectional view of a fifth exemplary embodiment of an elastic supporting member according to the present invention. For convenience of illustration, the same functional elements as those in the second exemplary embodiment, shown in FIG. 6, are represented by the same reference numerals, and a detailed description thereof will be omitted. Thus, the following description will be focused on such differences.

The supporting member 570 includes a base 172, and an elastic supporting portion disposed on the base 172 and support the diffusion plate 142. Here, the base has a shape of a plate, and the elastic supporting portion includes a first elastic portion 274a, a second elastic portion 274b, a third elastic portion 274c, and fourth elastic portion 274d, which are disposed on the plate 172 and support the diffusion plate 142. Bottom ends of the first elastic portion 274a, the second elastic portion 274b, the third elastic portion 274c, and the fourth elastic portion 274d are connected to one another. A connecting portion is disposed between pairs of adjacent ones of the first elastic portion 274a, the second elastic portion 274b, the third elastic portion 274c, and the fourth elastic portion 274d. The connecting portion may be disposed between each pair of the first elastic portion 274a, the second elastic portion 274b, the third elastic portion 274c, and the fourth elastic portion 274d. Each of the first elastic portion 274a, the second elastic portion 274b, the third elastic portion 274c, and the fourth elastic portion 274d, and each of the connecting portions are disposed directly on and contacting the base 172, as illustrated in FIG. 8.

Top ends of the first elastic portion 274a, the second elastic portion 274b, the third elastic portion 274c, and the fourth elastic portion 274d are separated from one another. Accordingly, the elastic supporting member 570 may have elasticity in transverse and longitudinal directions.

When the elastic supporting member 570 is inserted into the lower receiving container 160 from the exterior side of the lower receiving container 160, distances between each of the first elastic portion 274a, the second elastic portion 274b, the third elastic portion 274c, and the fourth elastic portion 274d are reduced, thereby facilitating the inserting of the elastic supporting member 570.

In addition, when a force is applied in the longitudinal direction of the elastic supporting member 570, the distance between each of the first elastic portion 274a, the second elastic portion 274b, the third elastic portion 274c, and the fourth elastic portion 274d is increased, and an overall height of the elastic supporting member 570 is reduced. Since the elastic supporting member 570 is easily shrinkable in the longitudinal direction due to a force applied in the longitudinal direction of the elastic supporting member 370, scratches to the diffusion plate 142 contacting the upper end of the elastic supporting member 570 may be reduced or effectively prevented.

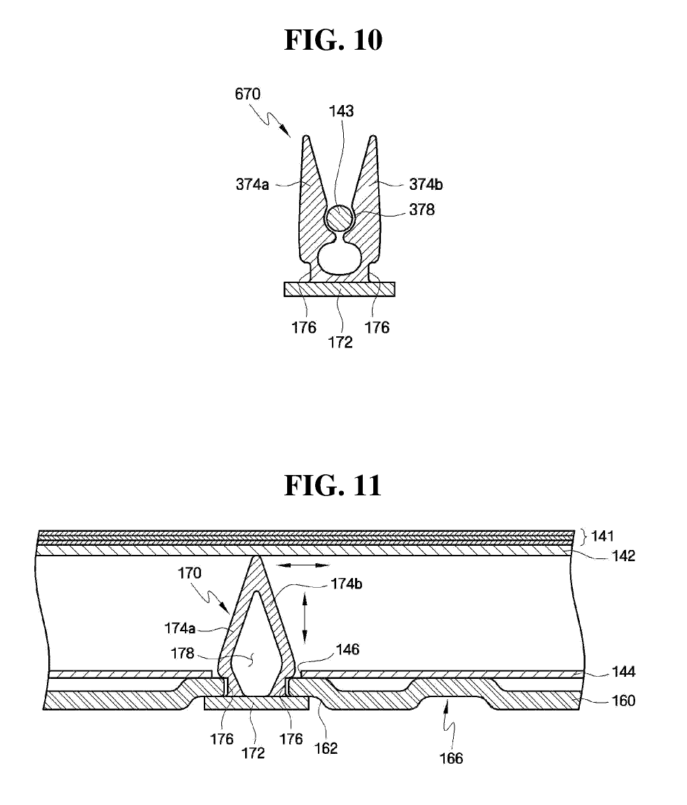

Hereinafter, an elastic supporting member according to a sixth exemplary embodiment of the present invention will be described with reference to FIG. 10. FIG. 10 is a cross-sectional view of a sixth exemplary embodiment of an elastic supporting member according to the present invention. For convenience of illustration, the same functional elements as those in the third exemplary embodiment, shown in FIG. 7, are represented by the same reference numerals, and a detailed description thereof will be omitted. Thus, the following description will be focused on such differences.

The elastic supporting member 670 includes a base 172, and an elastic supporting portion disposed on the base 172 and supporting the diffusion plate 142. Here, the base has a shape of a plate, and the elastic supporting portion includes a first elastic portion 374a and a second elastic portion 374b disposed on the plate 172 and supporting the diffusion plate 142. Bottom ends of the first elastic portion 274a and the second elastic portion 274b are connected to each other, such as to form an enclosed feature defined solely by the first elastic portion 374a and a second elastic portion 374b. As shown in FIG. 10, a connecting portion may be considered disposed between bottom ends of the first elastic portion 374a and a second elastic portion 374b. The first elastic portion 374a and a second elastic portion 374b are a single and continuous member, including the connecting portion. Each of the first elastic portion 374a and a second elastic portion 374b, and the connecting portion are disposed directly on and contact the base 172.

Top ends of the first elastic portion 374a and the second elastic portion 374b are separated from each other. The first elastic portion 374a and the second elastic portion 374b include a hollow portion in a region under the lamp inserting groove 378. The hollow portion is disposed between the lam inserting groove 378 and the connecting portion between the first elastic portion 374a and a second elastic portion 374b. Since bottom ends of the first elastic portion 374a and a second elastic portion 374b are connected to one another, respectively, such as to form an enclosed feature, a portion of the first elastic portion 374a and a second elastic portion 374b is disposed between the base 172 and the hollow portion. Accordingly, the elastic supporting member 670 may have elasticity in transverse and longitudinal directions.

When the elastic supporting member 670 is inserted into the lower receiving container 160 from the exterior side of the lower receiving container 160, a distance between the first elastic portion 374a and the second elastic portion 374b is reduced, thereby facilitating the inserting of the elastic supporting member 670. In another exemplary embodiment, after inserting the elastic supporting member 670 into the lower receiving container 160, the lamp 143 may be inserted into the elastic supporting member 670 to then be fixed thereto.

In addition, when a force is applied in the longitudinal direction of the elastic supporting member 670, the distance between each of the first elastic portion 374a and the second elastic portion 374b is increased, and an overall height of the elastic supporting member 670 is reduced. Since the elastic supporting member 670 is easily shrinkable in the longitudinal direction due to a force applied in the longitudinal direction of the elastic supporting member 670, scratches to the diffusion plate 142 contacting the upper end of the elastic supporting member 670 may be reduced or effectively prevented.

Hereinafter, an elastic supporting member according to a seventh exemplary embodiment of the present invention will be described with reference to FIG. 11. FIG. 11 is a cross-sectional view of a seventh embodiment of an elastic supporting member according to the present invention. For convenience of illustration, the same functional elements as those in the first exemplary embodiment, shown in FIGS. 1 through 5, are represented by the same reference numerals, and a detailed description thereof will be omitted. Thus, the following description will be focused on such differences.

According to this embodiment, since a throughhole 146 of a reflective plate 144 has a smaller diameter than a recess 162 of a lower receiving container 160, the reflective plate 144 is disposed on the deviated portion of the remaining portion of the bottom surface of the lower receiving container 160 defining the recess 162. Where the reflective plate 144 does not completely surface-contact the lower receiving container 160, but is separated from the lower receiving container 160, in order to prevent the reflective plate 144 from being deformed or sagging, an additional recess 166 that protrudes in an oblique manner from the periphery of a bottom surface of the lower receiving container 160 to the interior thereof, may be provided on the bottom surface of the lower receiving container 160. The lower surface of the reflective plate 144 contacts both the deviated portion of the remaining portion of the bottom surface of the lower receiving container 160 and an upper surface of the recess 166. The lower receiving container 160 may include a plurality of each of the recess 162 and 166 disposed across the receiving area.

While the elastic supporting member according to the first embodiment in FIGS. 3-5 has been illustrated in the seventh embodiment for brevity of explanation, the invention is not limited thereto and various supporting members according to other embodiments can also be used.

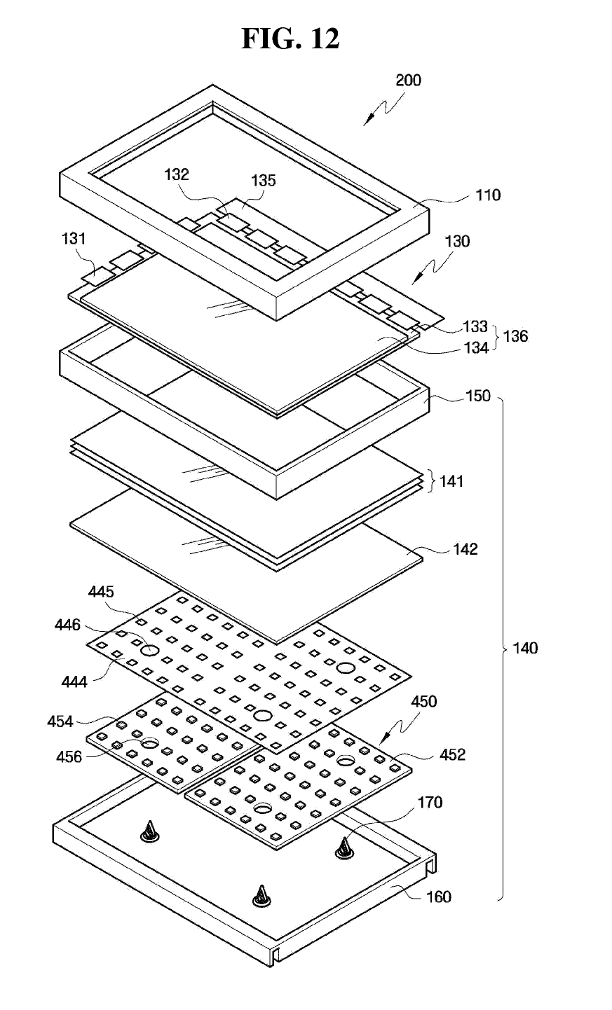

Hereinafter, a liquid crystal display (“LCD”) including an elastic supporting member according to an eighth exemplary embodiment of the present invention will be described with reference to FIG. 12. FIG. 12 is an exploded perspective view of another exemplary embodiment of an LCD including an elastic supporting member according to an eighth exemplary embodiment of the present invention. For convenience of illustration, the same functional elements as those in the first exemplary embodiment, shown in FIGS. 1 through 5, are represented by the same reference numerals, and a detailed description thereof will be omitted. Thus, the following description will be focused on such differences.

In the LCD 200 according to the illustrated embodiment, an LED assembly 450 used as a light source includes at least one substrate 452, and a plurality of an LED chip 454 disposed in the substrate 452. A first throughhole 456 is disposed in the substrate 452 of the LED assembly 450, and completely penetrates the substrate 452 such that the substrate 452 solely defines the first throughhole 456. A plurality of the first throughhole 456 may be arranged across the substrate 452. An elastic supporting member 170 supports a diffusion plate 142 by being inserted into the substrate 452 via the first throughhole 456.

A reflective plate 444 is disposed directly over the LED assembly 450. The reflective plate 444 includes a second throughhole 446 through which the elastic supporting member 170 passes, and a third throughhole 445 through which an LED chip 454 is inserted to upwardly expose the LED chip 454. In an alternative embodiment, a reflective material may be coated on a substrate 452, and the reflective plate 444 may be omitted. The first and second throughholes 456 and 446 are aligned such as to accommodate the elastic supporting member 170 inserted therethrough. The third throughhole 445 is aligned with the LED chip 454 such as to accommodate the LED chip 454 inserted therethrough.

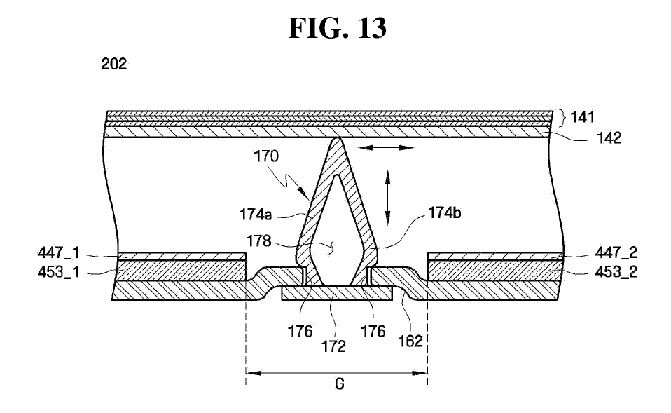

Hereinafter, a liquid crystal display (“LCD”) including an elastic supporting member according to a ninth exemplary embodiment of the present invention will be described with reference to FIG. 13. FIG. 13 is a cross-sectional view of a ninth embodiment of a liquid crystal display including an elastic supporting member according to a ninth exemplary embodiment of the present invention. For convenience of illustration, the same functional elements as those in the first exemplary embodiment, shown in FIGS. 1 through 5, are represented by the same reference numerals, and a detailed description thereof will be omitted. Thus, the following description will be focused on such differences.

In the LCD 202 according to the illustrated embodiment, an LED assembly 450 comprises a plurality of substrates 453_1, 453_2, and a plurality of an LED chip 454 disposed in the substrates 453_1, 453_2. Here, each of the plurality of substrates 453_1, 453_2 has the plurality of the LED chip 454. A gap G is formed between the adjacent substrates 453_1, 453_2. Reflective sheets 447_1. 447_2 are disposed on the substrates 453_1, 453_2, respectively. Here, the elastic supporting member 170 supports the optical members 141 and diffusion member 142 by being the adjacent substrates 453_1, 453_2.

While the elastic supporting member according to the first embodiment in FIGS. 3-5 has been illustrated in the present embodiment for brevity of explanation, the invention is not limited thereto and various supporting members according to other embodiments can also be used.

While the illustrated exemplary embodiments of the present invention explained above show the number of elastic portions forming an elastic supporting member as two or four, the present invention is not limited thereto.

In the illustrated embodiments, top ends of adjacent elastic supporting portions may be connected to one another, bottom ends of adjacent elastic supporting portions may be connected to one another, or both top ends and bottom ends of adjacent elastic supporting portions may be connected to one another.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A backlight assembly, comprising:
a light source generating light supplied to the liquid crystal panel;
optical members controlling characteristics of the light provided from the light source;
a receiving container including a receiving area receiving the light source and the optical members, a rear surface defining a plane, and a first recess protruding toward the receiving area from an exterior of the receiving container; and
an elastic supporting member assembled to the first recess of the receiving container, and supporting the optical members,
wherein the first recess has a depth from the plane of the rear surface, such that the supporting member does not protrude past the plane of the rear surface of the receiving container.

2. The backlight assembly of claim 1, wherein the elastic supporting member comprises:
a base disposed in the first recess, and facing a portion of the rear surface of the receiving container;
an elastic supporting portion disposed on the base, disposed in the receiving area of the receiving container, and supporting the optical members, and
a hooking groove disposed at an exterior side of the elastic supporting portion, the hooking groove engaged with a portion of the receiving container.

3. The backlight assembly of claim 2, wherein the base has a shape of a plate, and the first recess has a depth from the plane of the rear surface, such that the base does not protrude past the plane of the rear surface of the receiving container.

4. The backlight assembly of claim 3, wherein the elastic supporting portion includes first and second elastic portions, and top ends of the first and second elastic portions are connected to each other and define an opening portion between the first and second elastic portions.

5. The backlight assembly of claim 3, wherein the elastic supporting portion includes first through fourth elastic portions, and top ends of the first through fourth elastic portions are separated from one another.

6. The backlight assembly of claim 3, further comprising a reflective plate disposed between the light source and the receiving container, reflecting light upward from below the light source, and including a throughhole through which the supporting member passes, wherein the throughhole has a larger diameter than the first recess, and the reflective plate completely surface-contacts the receiving container.

7. The backlight assembly of claim 3, further comprising a reflective plate disposed between the light source and the receiving container, reflecting light upward from below the light source, and including a throughhole through which the supporting member passes, wherein the throughhole has a smaller diameter than the first recess.

8. The backlight assembly of claim 7, wherein the receiving container further includes a second recess contacting a lower surface of the reflective plate.

9. The backlight assembly of claim 3, wherein the light source comprises an LED assembly, the LED assembly comprising a substrate, and LED chips disposed on the substrate.

10. The backlight assembly of claim 9, wherein the elastic supporting member supports the optical members by being inserted into the substrate via a first through hole formed in the substrate.

11. The backlight assembly of claim 9, wherein the LED assembly comprises a plurality of substrates, and the elastic supporting member supports the optical members by being disposed between the adjacent substrates.

12. A display apparatus comprising:
a liquid crystal panel displaying image information;
a light source generating light supplied to the liquid crystal panel;
optical members arranged between the liquid crystal panel and the light source, and controlling characteristics of the light;
a receiving container including a receiving area receiving the light source and the optical members, a rear surface defining a plane, and a first recess protruding toward the receiving area from an exterior of the receiving container; and
an elastic supporting member assembled to the first recess of the receiving container, and supporting the optical members,
wherein the first recess has a depth from the plane of the rear surface, such that the supporting member does not protrude past the plane of the rear surface of the receiving container.

13. The display apparatus of claim 12, wherein the elastic supporting member comprises:
a base disposed in the first recess, and facing a portion of the rear surface of the receiving container;
an elastic supporting portion disposed on the base, disposed in the receiving area of the receiving container, and supporting the optical members; and
a hooking groove disposed at an exterior side of the elastic supporting portion, the hooking groove engaged with a portion of the receiving container.

14. The display apparatus of claim 13, wherein the base has a shape of a plate, and the first recess has a depth from the plane of the rear surface, such that the base does not protrude past the plane of the rear surface of the receiving container.

15. The display apparatus of claim 14, wherein the elastic supporting portion includes first and second elastic portions, and top ends of the first and second elastic portions are connected to each other and define an opening portion between the first and second elastic portions.

16. The display apparatus of claim 14, wherein the elastic supporting portion includes first through fourth elastic portions, and top ends of the first through fourth elastic portions are separated from one another.

17. The display apparatus of claim 14, further comprising a reflective plate disposed between the light source and the receiving container, reflecting light upward from below the light source, and including a throughhole through which the supporting member passes.

18. The display apparatus of claim 17, wherein the throughhole has a smaller diameter than the first recess, and the receiving container further includes a second recess contacting a lower surface of the reflective plate.

19. The display apparatus of claim 14, wherein the light source comprises an LED assembly comprising at least one substrate and LED chips disposed on the substrate,
and wherein the elastic supporting member supports the optical members by being inserted into the substrate via a first through hole formed in the substrate.

20. The display apparatus of claim 14, wherein the light source comprises an LED assembly comprising a plurality of substrates and LED chips disposed on the substrate,
and the elastic supporting member supports the optical members by being disposed between the adjacent substrates.
